(19) United States
(12) Patent Application Publication
(10) Pub. No.: US 2014/0250447 A1
(43) Pub. Date: Sep. 4, 2014

(54) SYSTEMS AND METHODS FOR PROVIDING A PRIVATE VIEWING EXPERIENCE

(71) Applicant: United Video Properties, Inc., Santa Clara, CA (US)

(72) Inventor: Martin Schink, Aachen (DE)

(73) Assignee: United Video Properties, Inc., Santa Clara, CA (US)

(21) Appl. No.: 13/948,369

(22) Filed: Jul. 23, 2013

Related U.S. Application Data
(60) Provisional application No. 61/772,231, filed on Mar. 4, 2013.

(51) Int. Cl. H04N 21/442; H04N 21/478

(52) U.S. Cl. CPC H04N 21/44218; H04N 21/478
USPC 725/10

(57) ABSTRACT

System and methods are presented for providing a user with a private viewing experience. In some embodiments, a private viewing system detects that the user is present at a media device that is displaying media content to the user, and then detects that a second user is outside of the viewing area of the media device. The private viewing system then determines a likelihood value related to the likelihood that the second user will enter the viewing area of the media device during a time period in the future. A first indication is then generated, based on the determined likelihood value, and presented to the user at the media device indicating that the second user is likely to enter the viewing area of the media device during the time period in the future.

### CROSS-REFERENCE TO RELATED APPLICATION

This application claims the benefit of U.S. Provisional Patent Application No. 61/772,231, filed Mar. 4, 2013, which is hereby incorporated by reference herein in its entirety.

### BACKGROUND

Current media systems allow access to virtually any type of content in the privacy of one's home. If a user wishes to view content in private, but shares a home with one or more individuals, there are various options available for preventing others from discovering the user's viewing history.

However, current methods do not provide a way of preventing others from intruding on the viewer's private viewing session while the user is actively viewing the content. It is difficult for the user to conceal his private content if he is unaware of his surroundings, and it may be too late once he discovers that an intruder is present. Moreover, even if a user is successful in concealing the content, doing so haphazardly may appear suspicious to the intruder.

### SUMMARY

These and other objects are accomplished in accordance with the principles of the present invention by providing a private viewing experience that allows a user to privately view content at a media device. A private viewing system can provide various indications to the user in response to detecting that another user is approaching the viewing area.

In some embodiments, the private viewing system may determine that a user is present at a media device that is displaying media content by, for example, facial recognition of the first user or monitoring activity of the user at the media device. A private viewing mode may be automatically enabled by determining that the first user is viewing content designated as “private content.” For example, a characteristic of the media content may be matched against a characteristic of content that has been designated as private content. Private content may include adult content, an R-rated movie, confidential information, or any other type of content that the user or the private viewing system may designate as such.

In some embodiments, the private viewing system may detect that a second user is outside the viewing area of the media device. For example, the activity of the second user at a remote device that is outside of the viewing area may be monitored. The private viewing system may also detect movement or motion of the second user outside of the viewing area by devices that are available through a communications network associated with the private viewing system.

In some embodiments, the private viewing system will determine a likelihood value, which is a probabilistic value related to the likelihood that the second user will enter the viewing area during a time period in the future. For example, the likelihood value may be based on the direction in which the second user is moving and the second user's relative location to the viewing area. For example, position information may be determined by various detection devices on the communications network. The private viewing system may then extrapolate a future position of the second user with respect to the viewing area based on previously determined locations of the second user, and assign a value to the likelihood value based on this information. The likelihood value may also be based on whether or not the second user is approaching the viewing area, and if the second user is detectable by a remote device in the communications network.

In some embodiments, the private viewing system will generate an indication based on the likelihood value, which is then provided to the first user. The indication may be a visual indication, an audio indication, or a way in which the content is presented to the user at the media device. The indication reflects the likelihood that the second user will enter the viewing area during a time period in the future. A characteristic of the indication may vary as a function of the likelihood value. For example, an intermittent display message may appear with a frequency related to the likelihood value.

In some embodiments, the indication generated by the private viewing system may be a warning displayed to the first user by the media device. The indication may also provided to the first user by automatically hiding the media content and displaying different media content. The different media content may be selected by the private viewing system if a characteristic matches a content characteristic that has been designated as “safety content.” The private viewing system may determine which indication to provide to the second user by determining if the likelihood value exceeds particular threshold values. For example, a warning message indication may be displayed based on a low likelihood value. If the likelihood value increases in response to the close proximity of the second user to the viewing area, the likelihood may exceed a particular threshold. As a result, the warning message indication may no longer be displayed, and instead the private content will be switched to safety content.

### BRIEF DESCRIPTION OF THE DRAWINGS

The above and other features of the present invention, its nature and various advantages will be more apparent upon consideration of the following detailed description, taken in conjunction with the accompanying drawings, and in which:

FIG. 1 is a diagram of an interactive grid display in accordance with some embodiments of the disclosure.

FIG. 2 is a diagram of an interactive media system in accordance with some embodiments of the disclosure.

FIG. 3 is a block diagram of an illustrative user equipment device in accordance with some embodiments of the disclosure.

FIG. 4 is a block diagram of an illustrative media system in accordance with some embodiments of the disclosure.

FIGS. 5A-D show an illustrative embodiment of systems and methods for providing a private viewing experience in accordance with some embodiments of the disclosure.

FIG. 6 is an illustrative private viewing options screen of a user device showing selectable private viewing options in accordance with some embodiments of the disclosure.

FIG. 7A-D illustrate the detection of user 510 approaching the viewing area in accordance with some embodiments of the disclosure.

FIGS. 8A-C show illustrative schematics for predicting the location of user 510 with respect to the viewing area in accordance with some embodiments of the disclosure.

FIG. 9 is a flow-chart of the illustrative steps involved in providing a private viewing experience in accordance with some embodiments of the disclosure.

FIG. 10 is a flow-chart of the illustrative steps involved in providing various indications to first user in response to tracking the locations of a second user in accordance with some embodiments of the disclosure.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

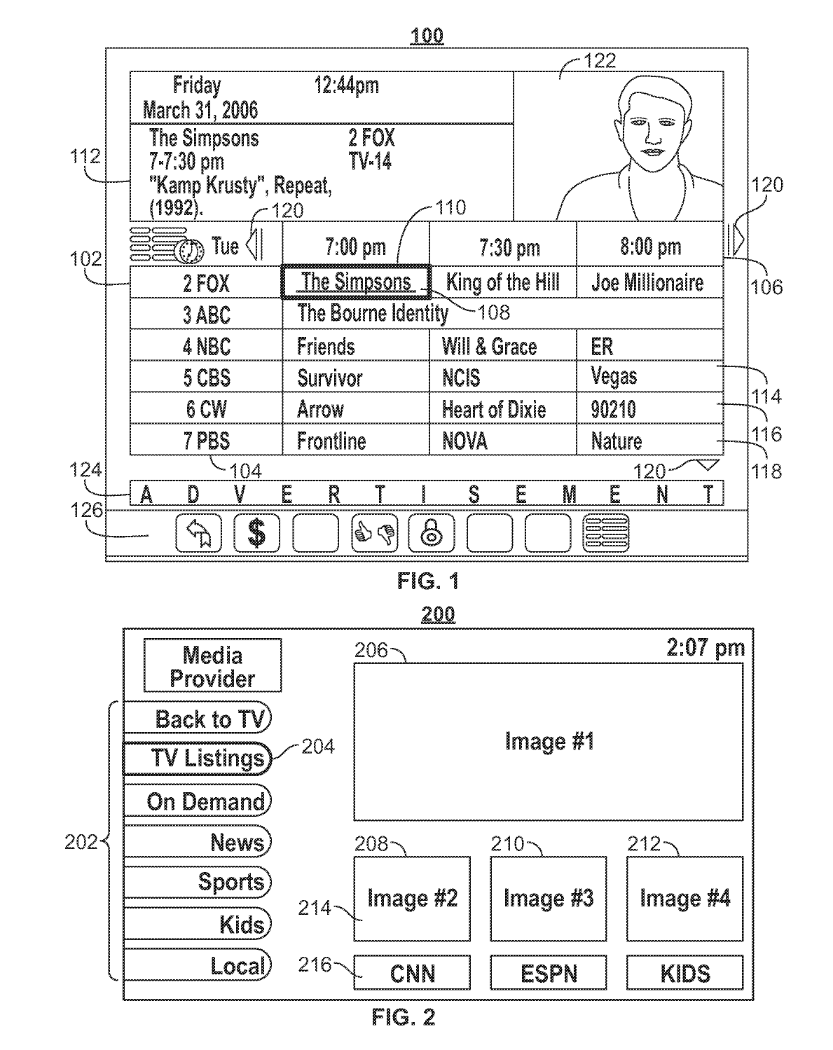

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, private viewing settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

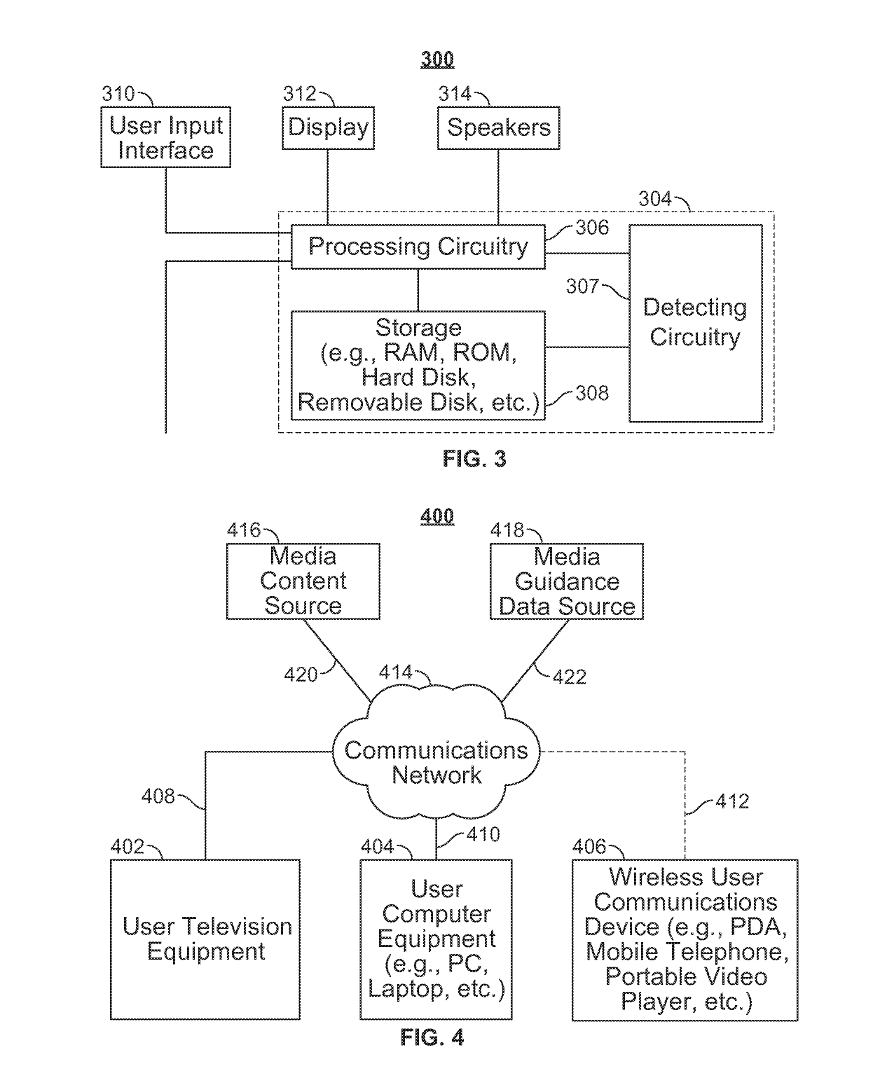

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

In some embodiments, control circuitry 304 may include detecting circuitry 307 which may be capable of detecting and/or identifying a user or users without requiring the user or users to make any affirmative actions by using any suitable biometric recognition technique, such as, facial recognition, heat signature recognition, odor recognition, scent recognition, body shape recognition, voice recognition, behavioral recognition, or any other suitable biometric recognition technique. For example, detecting circuitry 307 may detect and identify users using these techniques while the users are beyond a tangible distance to a media device. In some embodiments, users may be detected and/or identified using any other suitable biometric recognition technique that may, in some embodiments, require the users to be within a tangible distance to a media device, for example, iris recognition, retinal recognition, palm recognition, finger print recognition, or any other suitable technique. Systems and methods for automatically detecting users within detection regions of media devices are is discussed in, for example, Shimy et al., U.S. Patent Application Publication No. 2011/0069940, filed Sep. 23, 2009, which is hereby incorporated by reference herein in its entirety.

Detecting circuitry 307 may also be capable of detecting and/or identifying a user or users based on recognition and/or identification of a media device (e.g., a mobile device, such as an RFID device or mobile phone) that may be associated with the user or users. Detecting circuitry 307 may recognize and identify such a device using any suitable means, for example, radio-frequency identification, Bluetooth, Wi-Fi, WiMax, internet protocol, infrared signals, any other suitable IEEE, industrial, or proprietary communication standards, or any other suitable electronic, optical, or auditory communication means. For example, detecting circuitry 307 may determine that a user is within a predetermined detection region of a media device, identify the user, and add the user to a list of active users at the media device. The detection and identification of users as described herein does not require any affirmative action on the part of the user beyond, in some embodiments, the configuration of such methods and systems. For example, any detection and identification of users is done automatically by media devices.

Detecting circuitry 307 may include any suitable hardware and/or software to perform detection and identification operations. For example, detecting circuitry 307 may include infrared, optical, and/or radio-frequency receivers and/or transmitters. Detecting circuitry 307 may additionally, or alternatively, include one or more microphone and/or camera to detect audible and/or visual information, respectively. The microphone may be capable of receiving sounds within the audible range and/or outside the audible range. The camera may be capable of capturing information within the visual spectrum and/or outside the visual spectrum. For example, the camera may be able to capture infrared information, ultraviolet information, or any other suitable type of information. Detecting circuitry 307 may additionally, or alternatively, include palm, fingerprint, and/or retinal readers for detecting and/or identifying users. In some embodiments, detecting circuitry 307 may communicate to processing circuitry 306 and/or storage 308 various detection and/or identification mechanisms indicating whether a user is detected by and/or identified at a particular device.

In some embodiments, detecting circuitry 307 may use any suitable method to determine the distance, trajectory, and/or location a user is in relation to a media device. For example, a media device may use received signal strength indication (RSSI) from a user's mobile device to determine the distance the user is to the media device. For example, RSSI values may be triangulated to determine a user's location. The media device may also use, for example, triangulation and/or time difference of arrival determination of appropriate information to determine a user's location in relation to a media device. For example, time difference of arrival values of sounds emanating from a user may be determined. In some embodiments, any suitable image processing, video processing, and/or computer vision technique may be used to determine a user's distance, trajectory, and/or location in relation to a media device. A user's distance, trajectory, and/or location in relation to a media device may be determined using any suitable method.

User equipment device 300 of FIG. 3 can be implemented in private viewing system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In private viewing system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

Private viewing system 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Private viewing system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, user 510 equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some instances, a user of a user media equipment device may wish to prevent another user from observing “private” content that is currently being displayed by the user equipment device. In such instances, the user may wish to receive a warning from the media equipment device that another user is approaching. In the event that intrusion is imminent, the user may also desire to have the private content hidden from user 510 prior to the intrusion by having different content displayed that the user does not consider to be private. It should be understood that the terms “second user” and “another user” refer to any person that a user of private viewing system 400 wishes to detect in order to prevent intrusion into viewing area 506 when private content is presented.

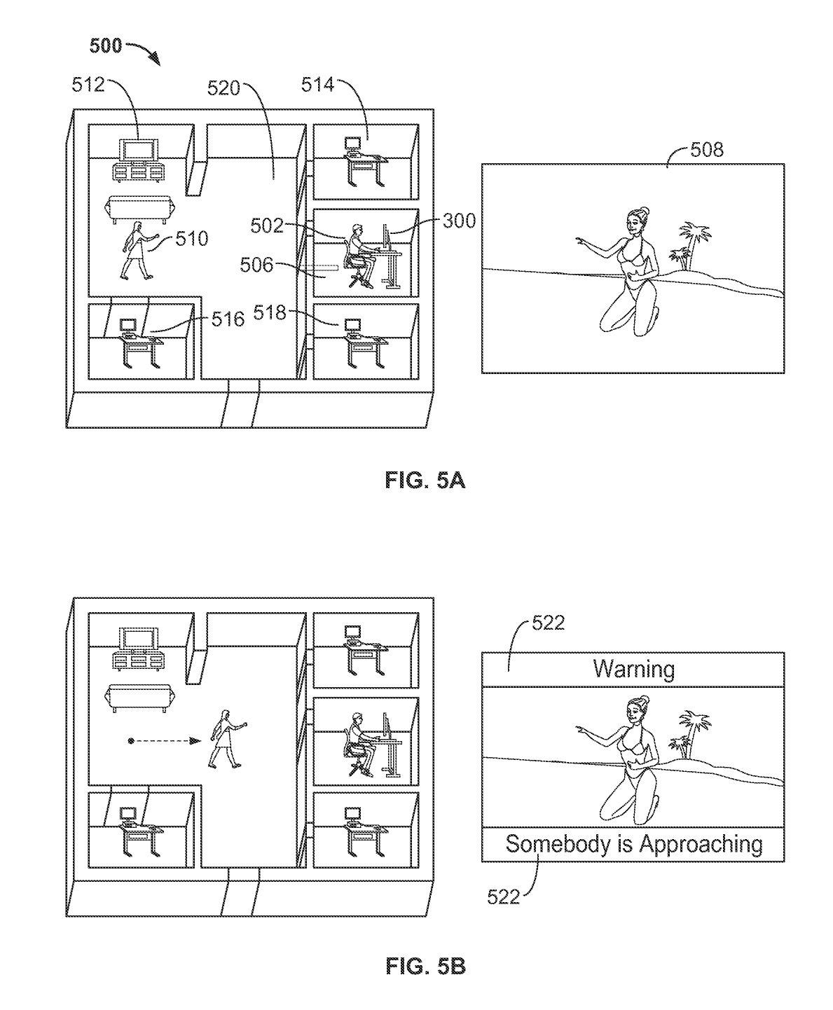

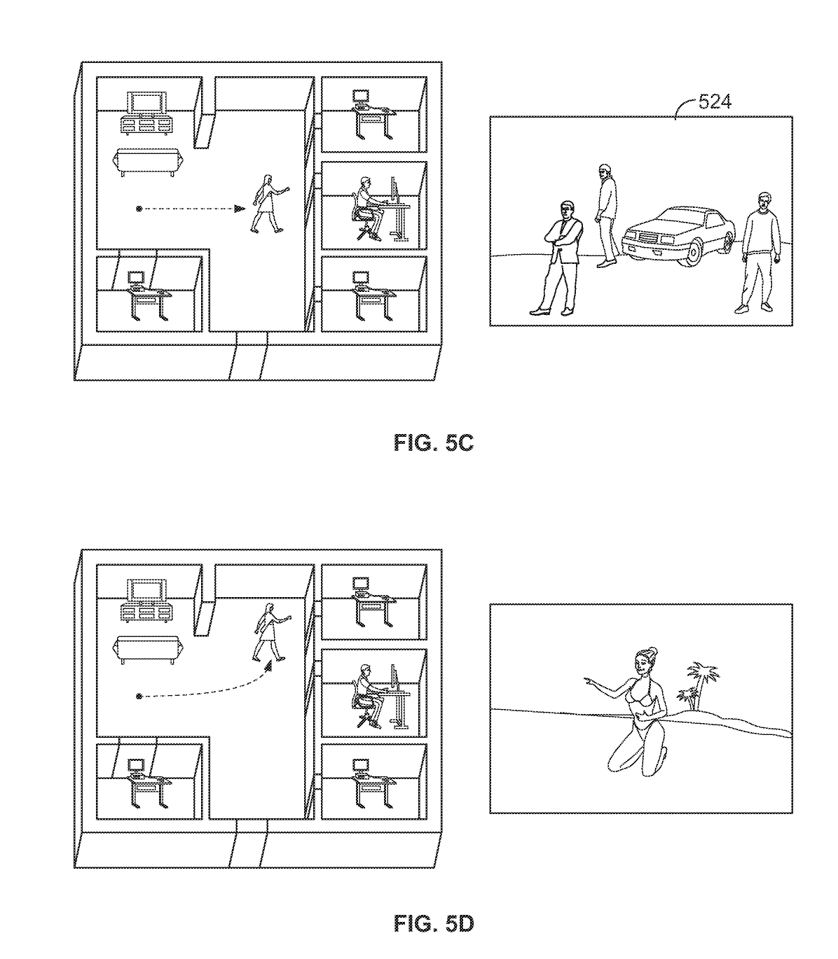

FIGS. 5A-D show an illustrative embodiment of systems and methods for providing a private viewing experience using private viewing system 400. FIG. 5A shows location 500 in which user 502 is using user equipment device 300 within viewing area 506. It should be understood that location 500 may be an office, a home, or various other locations for which a viewing area can be provided for viewing private content. Viewing area 506 may be any physical region for which the content of user equipment device 300 is observable. Viewing area 506 need not be enclosed by physical walls. For example, if user 502 is far enough away from user equipment device 300 and cannot clearly observe the content, user 502 may be considered outside of viewing area 506. Once it is determined by detecting circuitry 307 that user 502 is in viewing area 506, user 502 may desire to view media content at user equipment device 300 by enabling a private viewing mode.

The private viewing mode may be a feature included within a media guidance application, or may be standalone software implemented on a user media device. User 502 may actively enable a private viewing mode with user input interface 310, or any other device of private viewing system 400. In some embodiments, user 502 may not actively enable the private viewing mode, but may choose a setting that automatically enables the private viewing mode depending on the nature of the content that user 502 is viewing. For example, if user 502 is viewing adult content at user equipment device 300, control circuitry 304 may determine that the private viewing mode should be enabled based on a characteristic of the content (i.e. that it is adult content). In some embodiments, user 502 may specify, using user input interface 310, particular programs or types of programs that will cause the private viewing mode to be enabled automatically. In some embodiments, control circuitry 304 may automatically determine that private media content 508 should be treated as private content by comparing a characteristic of media content presented by user equipment device 300 with a characteristic that is designated as private content. For example, this characteristic may be a rating, title, genre, or any other characteristic of media content for which a comparison can be made. In some embodiments, if user 502 is viewing a confidential document, control circuitry 304 may determine that the document is private content by detecting the occurrence of the term “confidential” throughout the document. A database of private content designations may be stored in storage 308.

In FIG. 5A, user 502 is viewing private media content 508 at user equipment device 300. Private media content 508 may be any type of media content that the user may wish to hide from other user 510. For example, the user may be viewing video content containing a salacious, bikini-clad woman, and may enable the private viewing mode to prevent his wife from entering viewing area 506 and discovering the content.

In some embodiments, detecting circuitry 304 may determined that user 510 is not approaching viewing area 506 by monitoring the interactions of the second user with any of a plurality of remote devices 512, 514, 516, 518 associated with private viewing system 400. For example, user 510 may be interacting with television equipment 512 by changing the channel or volume. In this instance, control circuitry 304 may determine that user 510 is outside of viewing area 506 of user equipment device 300 and is not approaching viewing area 506. In some embodiments, remote devices 512, 514, 516, 518 may have facial recognition capabilities that can indicate to control circuitry 304 that the second user is in front of a particular remote device that is not within viewing area 506 of user equipment device 300.

In FIG. 5B, control circuitry 304 may determine that user 510 is moving in the direction of viewing area 506. In some embodiments, viewing area 506 may be a physically defined bounded region. Control circuitry 304 may determine the direction that user 510 is moving by comparing a change in the physical location user 510. Control circuitry 304 may then determine that user 510 is moving in a direction toward viewing area 506 by determining that extrapolating a line in the direction user 510 is moving would intersect a portion of the bounded region. In this way, control circuitry 304 may determine a likelihood value related to the likelihood that the second user may come into viewing area 506 of user equipment device 300 during a time period in the future. Control circuitry 304 may compute the likelihood value based on data received from the devices of private viewing system 400 over communications network 414, and store this likelihood value in storage 308. The position of user 510 relative to viewing area 506 may be determined by measuring the relative location of user 510 to each of a plurality of devices of private viewing system 400.

In some embodiments, remote devices 512 and 516 may be configured to determine the distance that user 510 is from each device, respectively, and communicate this information to control circuitry 304 over communications network 414. If the relative positions of remote devices 512 and 516 with respect to viewing area 506 are known, the relative location of user 510 with respect to viewing area 506 can be determined. Additional devices can be used to more accurately determine the location of user 510. In some embodiments, user equipment device 300 may be connected to a peripheral detection device located near an entrance to viewing area 506 (e.g. a doorway), which can determine, using detecting circuitry 307, that user 510 is moving toward viewing area 506 by detecting that user 510 is moving closer to the detection device. In some embodiments, any suitable combination of devices may be used to determine the location of user 510.

FIG. 5B illustrates an indication displayed to user 502 by display 312 that user 510 is approaching viewing area 506 in response to private viewing system 400 determining that user 510 is moving in a direction toward viewing area 506. In some embodiments, warning indication 522 may be a visual indication that user 510 is approaching viewing area 506. In some embodiments, warning indication 522 may appear as an overlay on display 312. The overlay may be translucent so as to not obstruct the content but visible enough to sufficiently warn user 502 that user 510 is approaching. In some embodiments, user 502 may customize the display properties of the overlay, such as the color, location, size, and message displayed with user input interface 310. User 502 may also customize the message of warning indication 522. If user 502 did not provide a customized message, a default message may be provided by control circuitry 304. In some embodiments, the visual characteristics of warning indication 522 may be a function of the likelihood value, which may vary continuously with relative location of user 510 to viewing area 506 or the relative velocity at which user 510 is approaching viewing area 506. For example, if user 510 is far away or walking slowly, control circuitry 304 will compute a low likelihood value. Control circuitry 304 will compute an opacity value based on the ratio of the likelihood value and a maximum likelihood value, which may correspond to user 510 physically entering viewing area 506, and display 312 will display warning indication 522 as a mostly translucent overlay based on the opacity value. As user 510 gets closer or is walking quickly, the opacity value will increase and warning indication 522 will appear mostly opaque. In some embodiments, the appearance of warning indication 522 may vary continuously with respect to the movements of user 510.

In some embodiments, display 312 may display the visual indication to user 502 intermittently. The frequency at which the visual indication is intermittently displayed may be a function of the relative location of user 510 to viewing area 506 or the speed of user 510. For example, control circuitry 304 may compute a likelihood value based on the distance that user 510 is from viewing area 506. Control circuitry 304 may then compute a frequency value that scales with the inverse of the likelihood value. If user 510 is 5 meters away from viewing area 506, display 312 may display the visual indication 1 time per second. If user 510 is 2 meters away from viewing area 506, display 312 may display the visual indication 4 times per second. In some embodiments, the frequency of the intermittent indication may be a function of the speed at which user 510 is approaching viewing area 506. In some embodiments, the frequency of the intermittent visual indication may vary continuously with respect to the movements of user 510.

In some embodiments, the warning indication may be an audio indication that user 510 is approaching viewing area 506. User equipment device 300 may generate a sound effect, such as a beeping sound, or may generate a voice that warns “somebody is approaching.” It should be understood that the indications are not limited to a single embodiment, and that any suitable combination of indications may be provided to user 510 by any appropriate device of private viewing system 400.

In some embodiments, the warning indication may be generated by a device that is different than user equipment device 300. For example, user 502 may be wearing a headset that is connected to the user equipment device 300 by any of the communications paths described herein. The warning indication may be in the form of an audio indication that is provided to user 502 through the headset. In some embodiments, the warning indication may be provided to user 510 by a mobile device by receiving the indication from private viewing system 400 over communications network 414.

In some embodiments, a warning indication may be provided to user 502 when user 510 has left a particular room and has entered an area for which viewing area 506 is accessible. For example, if user 510 was using device 516 in the room in which device 516 is located, detecting circuitry 307 of device 516 can detect that user 510 has left the room using any of the suitable methods described herein. If detecting circuitry 307 of device 516 or user input interface of device 516 is receiving input from user 510, control circuitry 304 may determine a likelihood value of zero, which corresponds to zero likelihood that user 510 will enter viewing area 506, and no warning indication will be provided to user 502. Once user 510 has left the room in which device 516 is located, user 510 is now in an area for which viewing area 506 is accessible and may approach viewing area 506 without having to enter or exit additional rooms. Control circuitry 304 will determine a low likelihood value and generate a warning indication that indicates to user 502 that user 510 may come into viewing area 506 during a time period in the future. In some embodiments, if detecting circuitry 307 has detected that user 510 has left a room but is not approaching viewing area 506, control circuitry 304 may generate a warning indication that is different from a warning indication that indicates that user 510 is approaching viewing area 506. In some embodiments, control circuitry 304 may assign a priority to a warning indication that user 510 is approaching viewing area 506, and control circuitry 304 may generate this warning indication instead of a warning indication that user 510 has left a room. In some embodiments, control circuitry 304 may generate a non-zero likelihood value when user 510 leaves a room and store the likelihood value in storage 308, in response to an indication received from a remote device over communications network 414. If detecting circuitry 307 detects user 510 approaching viewing area 506, control circuitry 304 will generate a new likelihood value that is greater than the previously stored likelihood value. If control circuitry 304 determines that the likelihood value exceeds a threshold value, control circuitry 304 may generate a new indication that is different from a previously generated indication. For example, a warning that indicates to user 502 that user 510 has left a room may be replaced by warning indication 522 if the likelihood value is determined by control circuitry 304 to exceed a threshold value.

Warning indication 522 of FIG. 5B may be displayed to user 502 even though there is some uncertainty as to whether or not user 510 will enter viewing area 506. Even if user 510 is moving in the general direction of viewing area 506, there is ample time for user 510 to change direction. Accordingly, control circuitry 304 may generate a likelihood value that is below a particular threshold value. FIG. 5C illustrates an intrusion indication 524 that is provided when control circuitry 304 determines that intrusion is imminent, which may occur in response to the likelihood value being equal to or exceeding a particular threshold value. In some embodiments, intrusion indication 524 may be provided by control circuitry 304 by instantaneously switching the content displayed by display 312 from the private content to content that is designated as safety content. For example, if control circuitry 304 determines that user 510 will enter viewing area 506 in a time period in the future based on an extrapolated location of user 510 relative to viewing area 506, the display of salacious, bikini-clad women may change to a random scene from a family TV show.

In some embodiments, user 502 has the option of manually changing the content from the private content to safety content. For example, when user 502 receives a warning indication, as shown in FIG. 5B, user 502 can press any button on user input interface 310. In such situations, control circuitry 304 may override the standard functions of user input interface 310 in order to receive a prompt notification from user 502 to change the content. In some embodiments, the warning message 522 may contain an additional indication that pressing any button on user input interface 310 will change the content.

If control circuitry 304 determines that user 510 is approaching viewing area 506 or is within a certain distance of user equipment device 300, the volume of any audio associated with the media content can be regulated control circuitry 304. User 502 may wish to enable this feature in order to prevent user 510 from hearing any audio content associated with the private content. In some embodiments, user 502 may calibrate private viewing system 400 in order to determine an acceptable volume level such that the volume will be effectively inaudible when user 502 is located at a particular distance from user equipment device 300. In some embodiments, the calibration may be determined automatically by using any suitable audio detection devices connected to communications network 414. Once private viewing system 400 is properly calibrated, it may control circuitry 304 can determine that user 510 is a particular distance away from user equipment device 300, the volume of the content will be decreased accordingly. As the distance between user 510 and user equipment device 300 decreases, the volume will be reduced. In some embodiments, the volume level may be varied with the inverse square of distance from user 510 to user equipment device 300. In some embodiments, user 502 may receive a visual indication that the volume of the media content is being reduced. This indication may be displayed in addition to the warning indication 522. In some embodiments, the volume will be reduced without any change to the visual display of the content.

In some embodiments, the intrusion indication 524 may be triggered when user 510 is within a predetermined range of viewing area 506. For example, intrusion indication 524 may be presented when user 510 crosses a threshold distance with respect to viewing area 506. User 502 may set this threshold distance, or it may be predefined by private viewing system 400.

FIG. 5D illustrates a situation in which control circuitry 304 determines that user 510 will not enter viewing area 506 at a time period in the future. If user 510 is approaching viewing area 506, as shown in FIG. 5B, the warning indication 522 may be provided to user 502. However, user 510 may quickly change direction before reaching viewing area 506. For example, this can occur if the entrance to viewing area 506 is located at a junction that splits into separate directions. Control circuitry 304 can determine if user 510 has changed direction by analyzing the last several measured locations of user 510 based on information received from detecting circuitry 307. Since user 510 would not be expected to make a sharp 90, degree turn, control circuitry 304 may only consider the last few time points in which a location was determined by detecting circuitry 307 when computing the likelihood value.

Configuration of private viewing system 400 can be performed by user 502 using a suitable interactive display implemented on user equipment device 300 by means of user input interface 310.

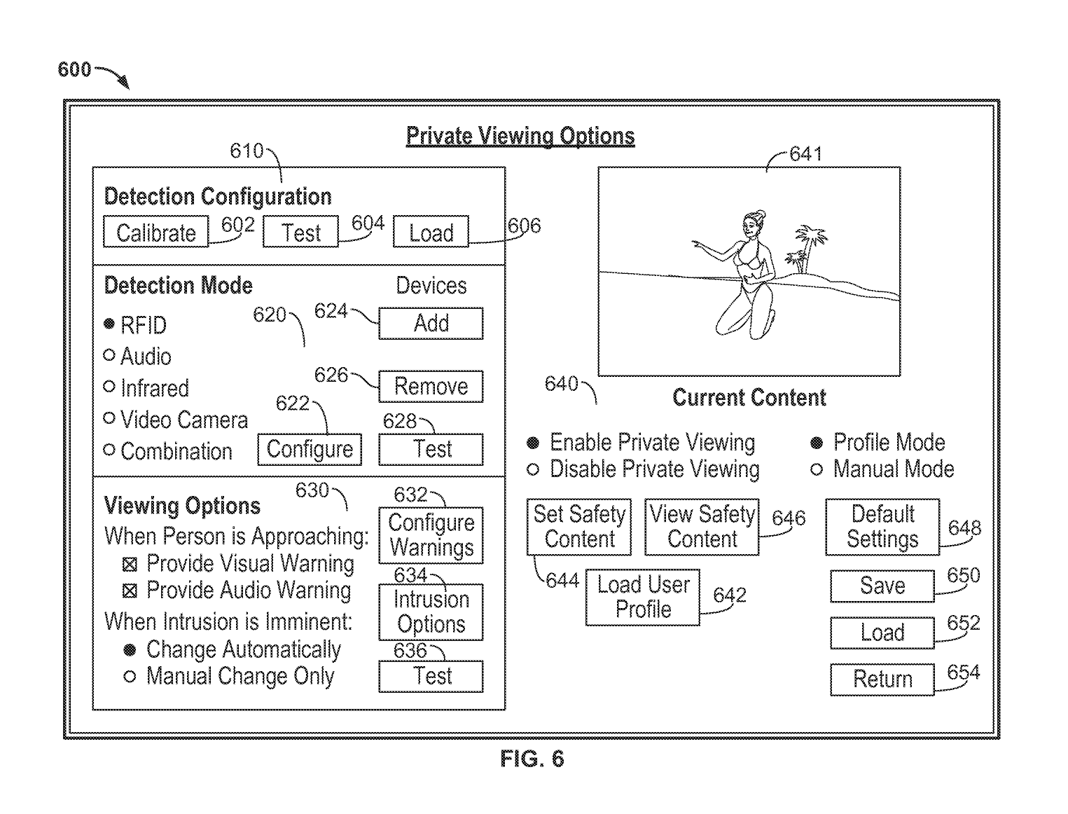

FIG. 6 is an illustrative private viewing options screen 600 of user equipment device 300 showing selectable private viewing options. User equipment device 300 may allow user 502 to select from a variety of options relating to the operation of private viewing system 400. Private viewing options screen 600 may include detection configuration options 610, detection mode options 620, viewing options 630, and content related options 640. Private viewing options screen 600 may be requested by user 502 at user equipment device 300 while user 502 is viewing private content or before user 502 decides to view private content. In some embodiments, detecting circuitry 307 may determine that user 502 is in front of a device for which the private viewing mode will be implemented. If user 502 previously indicated that private viewing options are to be automatically presented, actions such as retrieving from storage 308 a user profile associated with user 502, or facial recognition or other biometric detection methods described herein may be used to determine that user 502 is present at user equipment device 300, resulting in the appearance of private viewing options screen 600.

Detection configuration options 610 allow a user to define viewing area 506 of user equipment device 300 on which the private content is to be presented. For example, when user 502 selects the calibrate button 602, control circuitry 304 can compute a bounding region for which content presented by user equipment device 300 is observable. In some embodiments, user 502 may stand in various locations and have detecting circuitry 307 determine his location relative to user equipment device 300 using any suitable detection method, from which a bounding region can be computed. In some embodiments, control circuitry 304 may receive location data provided manually by user 502 at user input interface 310. In some embodiments, user 502 may specify a particular point relative to user equipment device 300 that serves as viewing area 506. For example, rather than specify a bounding region for viewing area 506, user 502 may designate a point in front of a doorway. Control circuitry 304 will then compute likelihood values based on the movements of user 510 relative to a bounding radial perimeter from the designated point.

Once private viewing system 400 is calibrated, user 502 can select the test button 604 to test private viewing system 400. This option allows user 502 to evaluate the calibration settings of private viewing system 400. In some embodiments, private viewing system 400, using detecting circuitry 307, may track the movement of user 502 when user 502 is outside of viewing area 506 using any suitable detection method. As user 502 moves around outside of viewing area 506, private viewing system 400 may maintain a log of the tracked positions of user 502 as well as a log of the warning indications. In some embodiments, the warning indications may be sent over the network to a mobile device that user 502 is carrying. This allows user 502 to see how the indications would be presented if the private viewing mode was enabled. User 502 may then use such feedback to re-calibrate private viewing system 400 if necessary.

If user 502 selects load button 606, control circuitry 304 will retrieve previous calibration settings from storage 308 to bypass the calibration step. In some embodiments, the calibration settings available for loading may be based on the availability of network devices for which location detection can be determined.

Detection configuration options 610 allow user 502 to select the method of detection of another user when the private viewing mode is enabled. User 502 may select from various detection methods, such as RFID, audio, infrared, video camera, or various combinations of detection modes. The detection methods are not limited to these methods, and any suitable method of detection may be used. User 502 may select configure button 622, which allows user 502 to choose which combination of detection methods to use. For example, user 502 may configure a hybrid detection method that detects the RFID tag associated with a mobile device carried by user 510 and may also use an infrared detection method in case user 510 is not carrying the mobile device with the RFID tag.

User 502 may choose to perform additional device-specific options by selecting add button 624, remove button 626, and test button 628. If user 502 selects add button 624, user 502 has the option of adding devices of communications network 414 to a list of devices that are to be monitored across private viewing system 400. The list of devices can be stored on and retrieved from storage 308. In some embodiments, user 502 may add his own devices to the list. For example, user 502 may install and add to the list a hidden camera to detect the motion of user 510. Control circuitry 304 will then retrieve data from the hidden camera over communications network 414 while the private viewing mode is enabled.

In some embodiments, user 502 may add one of the personal devices of user 510 to the list of devices used for detection if one of the devices of user 510 is accessible by user 502 through the communications network 414. For example, user 502 may choose to add a video camera used by user 510 to the list of devices. The video camera can be used to detect the presence of user 510 at a particular location outside of viewing area 506, and transmit this data to user equipment device 300 over communications network 414. If user 510 is no longer detectable by detecting circuitry 307 of the video camera, control circuitry 304 may then determine that user 510 has left the particular location, and an appropriate warning can be provided to user 502 at user equipment device 300 based on the determined likelihood value. In another example, remote devices 512, 514, 516, 518 can be added to the list of devices. The activity of user 510 at remote device 516 can indicate to control circuitry 304 that user 510 is at a particular location outside of viewing area 506. If activity at remote device 516 ceases for a short duration, this may indicate to control circuitry 304 that user 510 has left remote device 516, and an appropriate warning can be provided to user 502 at user equipment device 300 based on the determined likelihood value. Detection of user 510 at a remote device that is known to be outside of viewing area 506 can be accomplished by any suitable means.

In some embodiments, user 502 may configure private viewing system 400 to track multiple users in the vicinity of viewing area 506. User 502 may define a list of other users and define devices associated with those users. In some embodiments, control circuitry 304 may automatically populate the list of other users and associate devices with those users by importing available profile information associated with those users through communications network 414. In some embodiments, different threshold values may be associated with different users. For example, a child may have a higher threshold value than another adult who resides in location 500. This may correspond to the possibility that the viewing area would be less visible to a child intruding upon user 502, whereas another adult may have a better line of sight to user equipment device 300. As another example, the threshold value for a child may be low while the threshold value for another adult may be set so high as to not trigger any warnings. This may correspond to user 502 not wanting a child to see a violent movie scene, while user 502 may be fine with another adult intruding during the movie scene.

If user 502 selects remove button 626, user 502 will have the option of removing devices from the list of devices.

Viewing options 630 allow user 502 to select various options to configure how warning indications are provided by private viewing system 400. User 502 can select which warnings are received when user 510 is approaching. User 502 may choose to receive a visual warning indication, as illustrated in FIG. 5B, an audio warning indication, or both by selecting the appropriate checkboxes. User 502 may also select an intrusion option. For example, user 502 may select the “change automatically” option, which will cause control circuitry 304 to change the private content to safety content automatically when control circuitry 304 determines that an intrusion is imminent. Alternatively, user 502 can select a “manual change only” option to opt out of having the content changed automatically when control circuitry 304 determines that an intrusion is imminent. In some embodiments, a warning message may be displayed by display 312 when user 502 selects “manual change only” that warns user 502 of the potential risk that user 510 will discover the private content. For example, if user 502 has chosen the “change automatically” option, user 502 may manually change the content when a warning indication is generated.

If user 502 selects configure warnings button 632, user 502 can modify the way that warning indications are provided. For example, for visual indications, user 502 can customize the visual appearance of the indication by adjusting the size, appearance, color, and warning message displayed by display 312. In addition, user 502 may customize the manner in which the indication is displayed by selecting an intermittent display option and selecting the frequency of the intermittent display. In some embodiments, user 502 may configure the types of warnings that are displayed and when they are displayed. For example, user 502 may choose to have warning indications presented when control circuitry 304 has been determined that user 510 has left a particular room and has entered a region for which viewing area 506 is accessible. User 502 may select the number of times such warning indications are presented or may select to have the warning indication displayed continuously until control circuitry 304 determines that user 510 has entered a different room.

User 502 may set parameters to determine when to display warning indications. In some embodiments, user 502 may select to not display any warning indications until user 510 has entered a particular threshold distance with respect to viewing area 506. For example, if viewing area 506 is at the end of a long hallway, control circuitry 304 will not generate any warning indications until detecting circuitry 307 determines that user 510 is within 5 meters of viewing area 506.

User 502 can customize how warning indications are received. For example, user 502 can select to have warning indications sent to user equipment device 300. As a second example, user 502 can select to have warning indications sent to a mobile device of user 502 over communications network 414. As a third example, user 502 can select to have audio warning indications sent to a wireless headset worn by user 502.

User 502 can customize the manner in which a response to a warning indication can be provided. For example, user 502 can select an option to have control circuitry 304 change or hide private content in response to an input at user input interface 310, such as a keystroke or click of a mouse. In some embodiments, user 502 can choose to provide a verbal command such as “change” or “hide” in response to receiving a warning indication. Control circuitry 304 will interpret this audio command and respond accordingly.

User 502 can select intrusion options button 634 to configure the manner in which control circuitry 304 determines that an intrusion is imminent. User 502 may select and set a threshold option that presents the intrusion indication when user 510 has crossed a threshold distance with respect to viewing area 506. Control circuitry 304 may convert this threshold distance into a threshold value for comparison to a determined likelihood value. An intrusion indication will be provided to user 502, for example, if detecting circuitry 307 detects that user 510 has entered within one meter of the doorway leading to viewing area 506. In some embodiments, user 502 can customize the sensitivity of private viewing system 400. If a location tracking setting is enabled, user 502 can choose the frequency at which location detection is performed by detection circuitry 307 and the time period in the future in which location of user 510 is to be extrapolated. In some embodiments, the number of measurements to be used in predicting the location of user 510 may be set. For example, user 502 may choose to use the last five measurements to estimate the direction of user 510. In some embodiments, user 502 may select an option that causes control circuitry 304 to fit a curve to a series of previous locations of user 510 determined by detecting circuitry 307, which in turn is used to compute a likelihood value based on an extrapolated location at a time period in the future.

User 502 may configure how the intrusion indication is presented by user equipment device 300. In some embodiments, user 502 may configure how control circuitry 304 changes private content to safety content or hides private content. For example, if user 502 is viewing a television program on a television set, control circuitry 304 may change the channel. As a second example, if user 502 is streaming on demand content or viewing content provided by an electronic storage device, control circuitry 304 may display different on demand content at display 312 or have different content displayed instead of the content transmitted from the electronic storage device. As a third example, if user 502 is viewing an internet web page, a video game, or some other content that is displayed in a window or in a full-screen mode, control circuitry 304 may minimize the content, hide the content behind another on-screen window, or close the content entirely. As a fourth example, if a user is listening to music, engaging in an audio conference, or listening to other audio content, control circuitry 304 may mute the content or switch to another type of content.

User 502 can select test button 636 to simulate how various indications will be presented. For example, control circuitry 304 can generate a visual indication as it would be presented in the event that user 510 was approaching viewing area 506.

In some embodiments, private viewing options 600 allow user 502 to adjust content related options 640. In some embodiments, private content display 641 is a minimized version of the private content 508 that user 502 is currently viewing. User 502 may select “enable private viewing” or “disable private viewing” to enable or disable the private viewing mode. In some embodiments, user 502 may enable or disable the private viewing mode by pressing a key on an input device or by providing a voice command, and private viewing options 600 need not be displayed or accessible for private viewing system 400 to receive this input. In some embodiments, an overlay may be displayed by display 312 while user 502 is viewing private content that indicates whether the private viewing mode is enabled or disabled.

In some embodiments, user 502 can select between a profile mode and a manual mode. If profile mode is selected, control circuitry 304 will automatically select safety content based on stored profile information associated with user 502. If manual mode is selected, user 502 must manually specify the safety content.

In some embodiments, user 502 may select load user profile button 642. Control circuitry 304 will then retrieve from storage 308 profile information for user 502 associated with viewing history or preferences. Control circuitry 304 may then designate a program as safety content based on the preferences of user 502. For example, control circuitry 304 may determine that a particular sports program is often watched by user 502 and may designate it as the safety content. As another example, control circuitry 304 may determine that user 502 frequently listens to a particular music artist, and may designate a song by that artist as the safety content. In some embodiments, control circuitry 304 may match the type of safety content to the type of private content presented to user 502. For example, if user 502 is viewing an adult on-demand movie at user equipment device 300, the safety content selected by control circuitry 304 will also be an on-demand movie. As a second example, if user 502 is listening to a song with explicit lyrics at user equipment device 300, the safety content selected by control circuitry 304 will also be a song. In some embodiments, control circuitry 304 may designate the safety content in real-time. Control circuitry 304 may designate the safety content based on the type of private content that is currently being presented to user 502. In some embodiments, control circuitry 304 may select safety content based on frequently viewed content or content that is likely to be viewed by user 502. Control circuitry 304 may then compare a characteristic of the selected content to a content feature that is designated as safety content. For example, content with a PG rating may be automatically designated as safety content.

In some embodiments, if control circuitry 304 determines that intrusion by user 510 is imminent, the safety content will be presented and playback will start from an arbitrary location so as to provide the illusion that the safety content was being viewed prior to intrusion by user 510. In some embodiments, the safety content is designated based on a rating associated with the content. For example, safety content with a mature or adult rating may not be selected. Content that has previously been designated as private content will not be chosen as safety content. Profile mode eases the burden of user 502 having to select safety content by automatically designating safety content that would be convincing to user 510. By contrast, if safety content was arbitrarily chosen, user 510 may intrude and see user 502 watching a program that he would not normally watch, thus raising the suspicion of user 510.

User 502 may designate safety content manually by selecting set safety content button 644. In some embodiments, user 502 may select a playback location for the safety content. For example, if the safety content is a movie, user 502 may choose an arbitrary location in the movie for which playback should occur when the private content is switched to safety content. User 502 may choose to view the safety content by selecting view safety content button 646, which displays safety content that was either designated by user 502 or automatically selected by control circuitry 304 depending on if profile mode or manual mode was selected.

In some embodiments, user 502 may also select default settings button 648, save button 650, load button 652, and return button 654. Default button 648 will load from storage 308 pre-defined settings provided by private viewing system 400. Save and load buttons 650, 652 will save the current settings to storage 308 and load previous settings from storage 308, respectively. If user 502 selects return button 654, control circuitry 304 will hide private viewing options screen 600.

It should be understood that private viewing options 600 is illustrative, and may contain any suitable options and additional display screens to allow user 502 to configure private viewing system 400 based on the features disclosed herein.

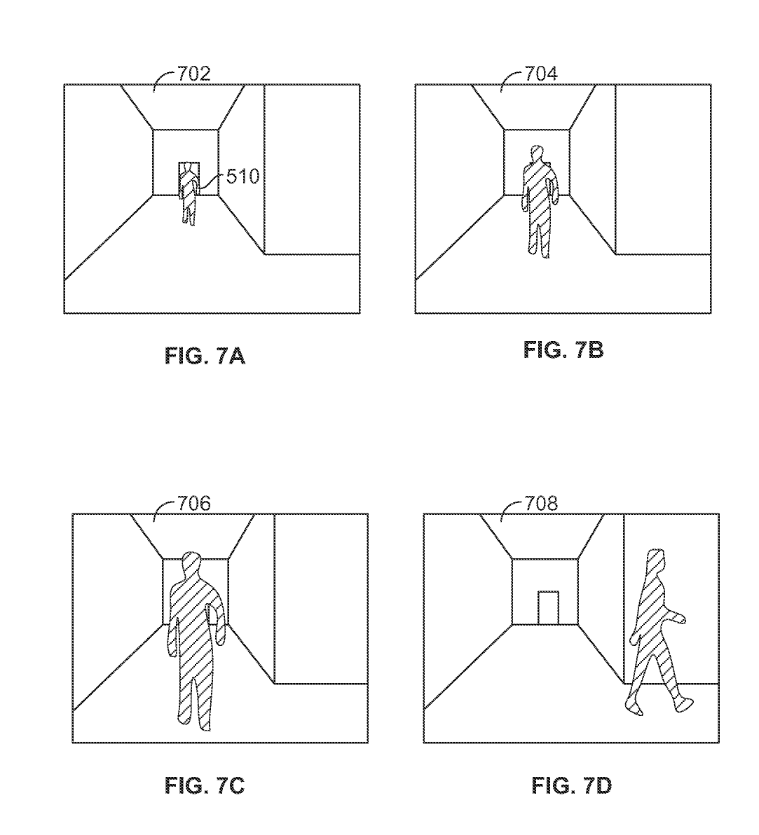

FIGS. 7A-D illustrate the detection of user 510 approaching viewing area 506. In this example embodiment, user 502 has selected the infrared option from private viewing options screen 600, and selected a detection device that is hidden near a doorway leading into viewing area 506. The detection device may determine, using detecting circuitry 307, that user 510 is a particular distance away from viewing area 506, based on previous calibrations. Control circuitry 304 may then compute a likelihood value based on this distance information. Control circuitry 304 may integrate the heat intensity provided by detecting circuitry 307 of the camera and correlate the integrated intensity with a particular distance relative to the camera. Control circuitry 304 may then use this data to determine the distance of user 510 relative to viewing area 506, and convert this information into a likelihood value. It should be understood that any suitable method of detecting user 510 may be used, and that infrared detection is an illustrative embodiment.

FIG. 7A shows an image 702 of user 510 determined to be far from viewing area 506, based on threshold settings of private viewing system 400. The initial appearance of a person into the area for which viewing area 506 is accessible may be determined by observing the appearance of a heat profile, and a warning indication may be provided accordingly.

FIG. 7B shows an image 704 of user 510 taken after a time interval. After determining the location of user 510 relative to viewing area 506, control circuitry 304 will make the determination that user 510 is approaching viewing area 506 by computing the direction in which user 510 is traveling. This calculation may be based, for example, on the integrated intensity of the heat profile as well as the relative location of the detected object in the detection window.

FIG. 7C shows an image 706 of user 510 taken after an additional time interval. After determining the location of user 510 relative to viewing area 506, control circuitry 304 may determine that user 510 will be within viewing area 506 at a time period in the future based on the previously computed positions, direction, and speed of user 510. This determination will also be made if user 510 has crossed a previously-defined threshold location with respect to viewing area 506. In both situations, an intrusion indication will be provided to user 502 by private viewing system 400.

FIG. 7D shows an alternative to the situation of FIG. 7C, where the image 708 of user 510 is taken after the image 704 of FIG. 7B was taken. After determining the location of user 510 relative to viewing area 506, control circuitry 304 may determine that user 510 has changed direction. Such motion may be determined by observing a shift in the heat profile of the detected object in the detection window. In this situation, any previously provided warning indications will be hidden and user 502 may continue viewing the private content at user equipment device 300 without interruption from private viewing system 400.

In accordance with the various embodiments disclosed herein, control circuitry 304 may track and predict a future location of user 510 as discussed below.

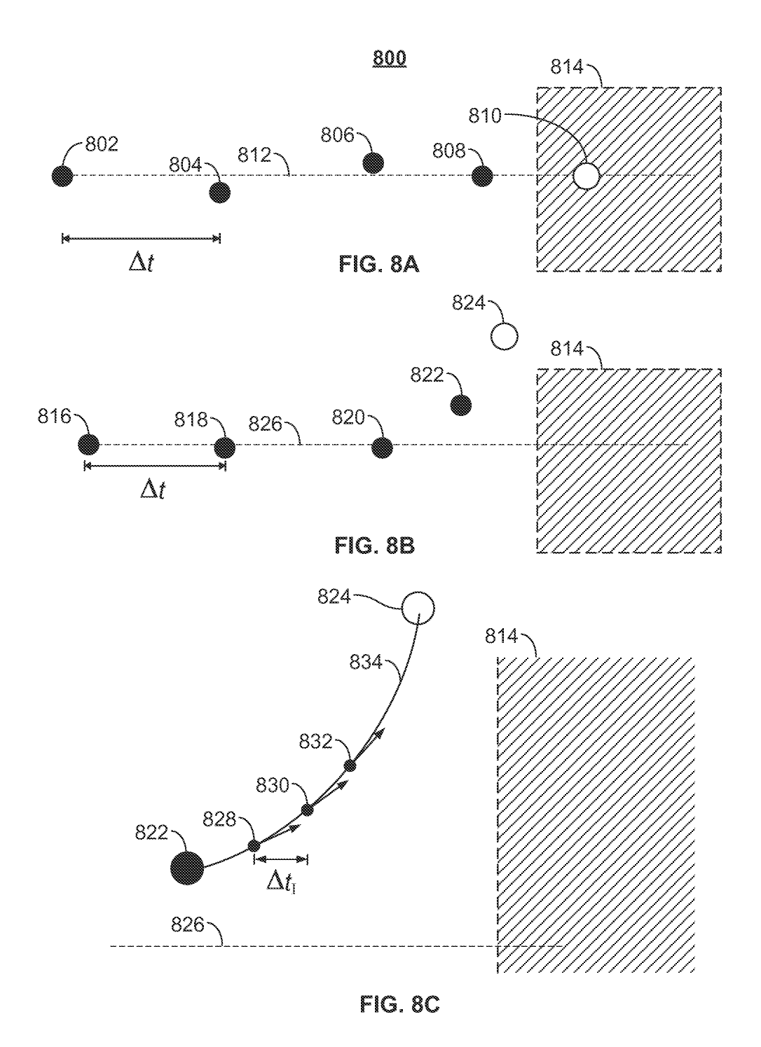

FIGS. 8A-C show illustrative schematics 800 for predicting the location of user 510 with respect to viewing area 506. FIG. 8A corresponds to the situation illustrated in FIGS. 7A-C and shows various locations 802, 804, 806, 808 at which user 510 is detected, a predicted location 810, an extrapolation 812 through locations 802, 804, 806, 808, and viewing area 814. In FIG. 8, user 510 is initially detected at location 802 using detecting circuitry 307. After a period of duration Δt, user 510 is detected at location 804. Subsequent locations 806, 808 are also detected after time duration Δt. Control circuitry 304 may compute the velocity of user 510 by computing average speed and direction. Average speed may be computed by dividing the total distance between locations 802 and 808 by 3*Δt. More generally, average speed |v| may be computed by the equation:

|v|=|d_{N}−d₁|/(Δt*(N−1))

where N is the number of location measurements taken, and dᵢ are position vectors relative to a common origin. The vector dᵢ corresponds to the earliest measurement taken and the vector d_{N} corresponds to the most recent measurement taken. In some embodiments, N may be a user-specified value.

Extrapolation 812 may be computed by fitting a line to locations 802, 804, 806, 808. In some embodiments, extrapolation 812 may be linear and obtained by control circuitry 304 performing a linear regression analysis. In some embodiments, extrapolation 812 may be computed based on a finite number of locations. For example, locations 802, 804, 806, 808 may be used to compute extrapolation 812. As a second example, locations 804, 806, 808 may be used to compute extrapolation 812, while location 802 may not be used as control circuitry 304 may designate it as too far in the past to have any meaningful correlation with the future position of user 510. In some embodiments, non-linear curve fitting may be performed by control circuitry 304. Non-linear curves may include arcs, semicircles, polynomials, exponential functions, logarithmic functions, trigonometric functions, power functions, Gaussian functions, and Lorenz curves. It should be understood that extrapolation 812 is illustrative, and that any suitable mathematical model may be used to fit the location data.

In some embodiments, extrapolation 812 can be computed by control circuitry 304 to determine if user 510 is approaching viewing area 506. For example, if control circuitry 304 determines that extrapolation 812 passes through viewing area 814, intersects a boundary of viewing area 814, or crosses a defined threshold relative to viewing area 814, control circuitry 304 may generate a warning indication to user 502 that user 510 is approaching viewing area 506 in accordance with any of the embodiments described herein.

In some embodiments, control circuitry 304 will extrapolate the next location of user 510 during a time period in the future. Control circuitry 304 can make this determination by extrapolating the location of user 510 to a future time based on the previously determined location and velocity of user 510. For example, predicted location 810 may be determined by control circuitry 304 by first computing the future distance d_{f}=t_{f}*|v| and then placing predicted location 810 at a distance d_{f} away from location 808 but constrained to extrapolation 812. In some embodiments, t_{f} is the same as Δt. In some embodiments, t_{f} is different than Δt and may be pre-defined or set by user 502.

In some embodiments, control circuitry 304 will predict that user 510 will be in viewing area 506 during a time period in the future by determining if predicted location 810 is within viewing area 814. In FIG. 8A, predicted location 810 is within viewing area 814, and an intrusion indication will be provided to user 502 in accordance with any of the embodiments described herein.

FIGS. 8B and 8C show an illustrative embodiment for detecting a sudden change in direction by user 510 that is approaching viewing area 506, corresponding to the situation illustrated in FIGS. 7A, 7B, and 7D. FIG. 8B shows locations 816, 818, 820, 822, predicted location 824, and extrapolation 826. Extrapolation 826 is a linear regression performed by control circuitry 304 based on locations 816, 818, 820, 822, which passes through viewing area 814 and may result in control circuitry 304 generating warning indication provided to user 502. Predicted location 824, however, was not predicted to lie within viewing area 814.

In some embodiments, intermediate locations 828, 830, 832 are determined in addition to locations 816, 818, 820, 822. The duration Δt_{I} is shorter than duration Δt. In some embodiments, extrapolation 826 may still be computed by control circuitry 304 based on locations 816, 818, 820, 822 to determine a general approach trajectory of user 510. Intermediate locations 828, 830, 832 are used to fit curve 834 in order to predict any sudden change in direction of user 510. An example is if user 510 must approach the viewing area while en route to a different destination and must turn just prior to reaching the viewing area in order to reach that destination, as shown in FIGS. 7A, 7B, and 7D. Predicted location 824 will then be determined based on an extrapolation of curve 834 at future time t_{f}. In some embodiments, user 502 may specify the number of intermediate locations to use in the fitting of curve 834. It should be understood that curve 834 may be one of any mathematically defined curve including arcs, semicircles, polynomials, exponential functions, logarithmic functions, trigonometric functions, power functions, Gaussian functions, and Lorenz curves.

Control circuitry 304 may compute a likelihood value based on location information received from detecting circuitry 307 from various devices across communications network 414. In some embodiments, the likelihood value may range from 0 to 1. A likelihood value of 0 may correspond to, for example, an indication from detection circuitry 307 of a remote device that user 510 is in a different room. As another example, a likelihood value of 0 may correspond to user 510 being completely absent from location 500. A likelihood value of 1 may correspond to detecting circuitry 307 determining that user 510 is physically within viewing area 506. In some embodiments, a likelihood value of 1 may correspond to control circuitry 304 that predicted location 810 of user 510 is within viewing area 814, as shown in FIG. 8B. In some embodiments, the likelihood value may vary continuously between a minimum and maximum value. For example, the likelihood value may range between 0 and 1. The likelihood value may be a weighted sum of location information obtained from detecting circuitry 307. For example, a component of the weighted sum may include the quantity 1−d/dₘₐₓ, where d is the distance of predicted location 810 from viewing area 814, and dₘₐₓ is a maximum relevant distance. The maximum relevant distance may correspond to a width or length of location 500. Another component of the weighted sum may include a computed speed of user 510. Another component of the weighted sum may include a baseline constant value that is added to the sum when control circuitry 304 determines that user 510 has left a room in location 500.

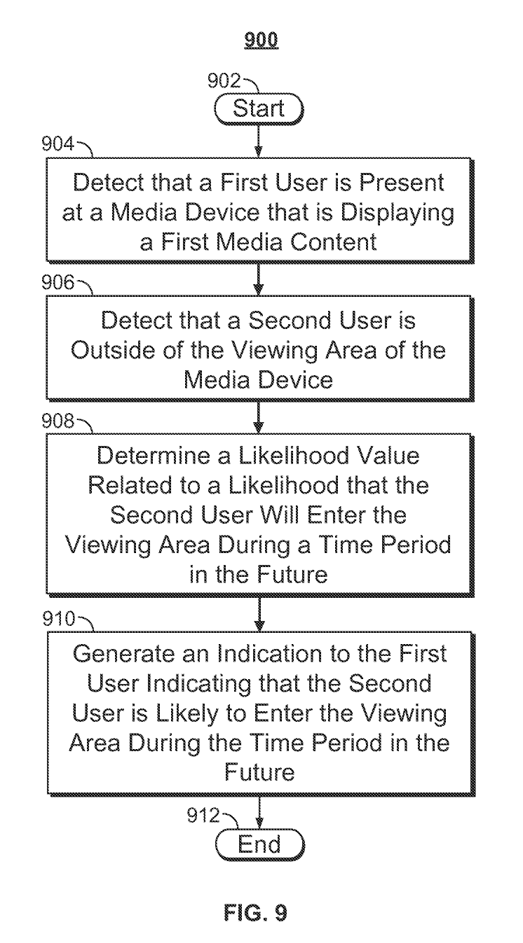

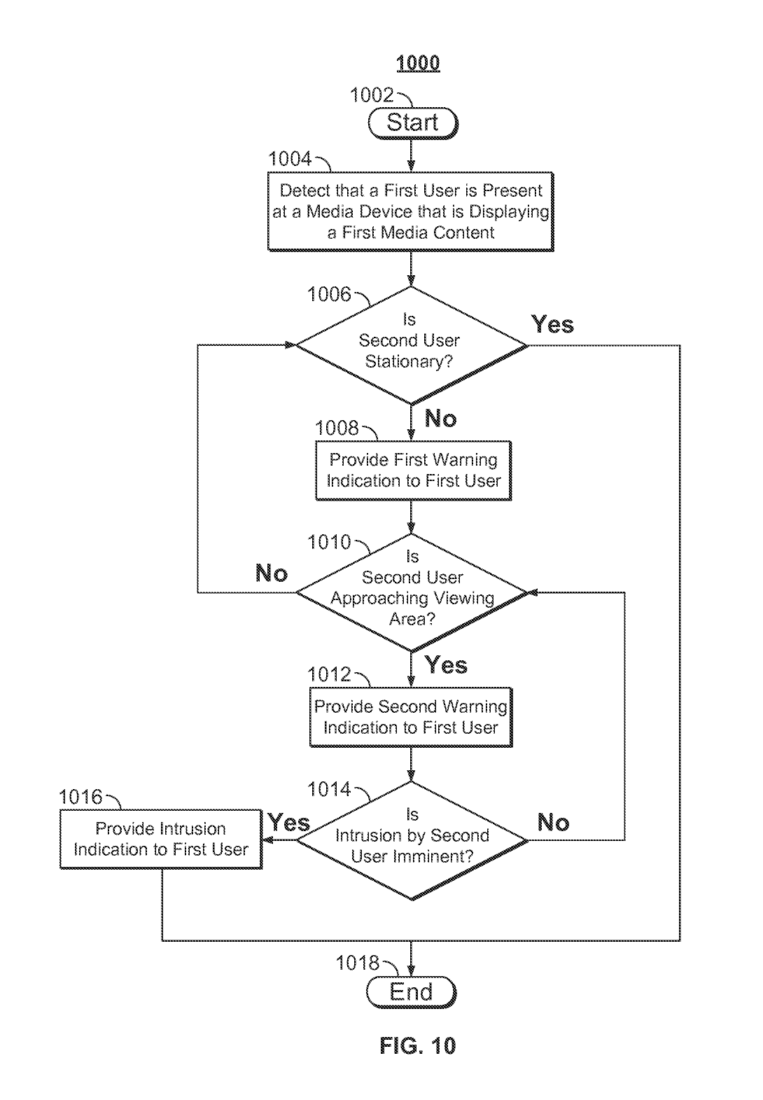

FIGS. 9 and 10 illustrate processes for providing a private viewing experience for user 502 at a user equipment device 300.

FIG. 9 is a flow-chart of the illustrative steps involved in providing a private viewing experience in accordance with some embodiments of the disclosure. Process 900 begins at step 902. At step 904, detecting circuitry 307 determines that a first user (e.g. user 502) is present at a media device that is displaying a first media content. Any suitable method may be used to determine if user 502 is present at user equipment device 300, including but not limited to monitoring user activity at user equipment device 300, facial recognition, and voice recognition. Control circuitry 304 may receive a command to enable the private viewing mode. Alternatively, control circuitry 304 may enable the private viewing mode without input from user 502. For example, if user 502 begins viewing content that was previously designated as private content, control circuitry 304 may automatically enable the private viewing mode.

At step 906, detecting circuitry 307 determines that a second user (e.g. user 510) is outside of viewing area 506 of user equipment device 300. Any suitable method disclosed herein may be used to detect that user 510 is outside of viewing area 506, including but not limited to monitoring activity from user 510 at remote devices, detection of user 510 by remote devices, and failing to detect user 510 at user equipment device 300. In some embodiments, the user 502 may provide a direct indication to control circuitry 304 that user 510 is not in viewing area 506. In some embodiments, control circuitry 304 may prevent previously designated private content from being viewed at user equipment device 300 if it is determined that user 510 is within viewing area 506 of user equipment device 300, and the process may skip back to step 904.

At step 908, control circuitry 304 determines a likelihood value that user 510 may come into viewing area 506 of user equipment device 300 at some time period in the future. Control circuitry 304 receives data from remote devices related to the location of user 510. Based on data received from the remote devices, control circuitry 304 may compute the location of user 510 relative to viewing area 506. In accordance with some embodiments disclosed herein, the private viewing mode may predict that user 510 will enter viewing area 506 at some time in the future. For example, control circuitry 304 may receive a communication from a remote device that user 510 is inactive, has stopped using the remote device, or has left the detectable range of the remote device and is now in a location for which viewing area 506 is accessible, and, based on this communication, control circuitry 304 will determine a likelihood value that is related to the likelihood that user 510 will enter viewing area 506 of user equipment device 300 during a time period in the future. As a second example, control circuitry 304 may receive data related to a location of user 510 from at least one remote device. Control circuitry 304 may then calculate the location of user 510 relative to viewing area 506 and the direction of travel of user 510. As a third example, control circuitry 304 may calculate the speed and trajectory of user 510 based on the received location data. Control circuitry 304 may then extrapolate, based on the speed and trajectory, a future location of user 510. Control circuitry 304 may then compute a likelihood value based on data related to the tracked movement of user 510.

At step 910, control circuitry 304 may generate an indication to the user 502 that user 510 is likely to be within viewing area 506 of user equipment device 300 at some time period in the future based on the likelihood value determined by control circuitry 304. The indication may be provided to user 502 in the form of a visual indication using display 312, an audio indication using speakers 314, or a change in the manner in which content is presented to user 502 by user equipment device 300. Control circuitry 304 may provide a visual indication by generating an overlay on display 312 while private content is presented, generating a display on any associated device displays that are currently accessible to user 502, or by any suitable combination thereof. Control circuitry 304 may provide an audio indication by generating a sound from any of the audio devices that are currently accessible to user 502, modulating of any audio associated with the private content, or by any suitable combination thereof. Control circuitry 304 may change the manner in which content is presented to user 502 by hiding the private content, changing the private content to safety content, or by any suitable combination thereof. Control circuitry 304 may receive a command from user 502 indicating that the manner in which content is presented to user 502 should be changed. The process concludes at step 912, and may repeat continuously starting from step 902.

FIG. 10 is a flow-chart of the illustrative steps involved in providing various indications to a first user in response to tracking the locations of a second user. Process 1000 begins at step 1002. At step 1004, control circuitry 304 determines that a first user (e.g. user 502) is present at user equipment device 300 that is displaying a first media content, in accordance with step 904 of FIG. 9.

If at step 1006 control circuitry 304 determines that a second user (e.g. user 510) is stationary, the process concludes at step 1018, and may repeat continuously from step 1002. If control circuitry 304 determines that user 510 is stationary, the likelihood value may be assigned a value of zero. Control circuitry 304 may determine that user 510 is stationary in response to receiving a communication over communications network 414 from a remote device that user 510 is actively interacting with the remote device, or that user 510 is detectable within a detection range of the remote device. If at step 1006 control circuitry 304 determines that a second user is not stationary, the process continues to step 1008. Control circuitry 304 may determine that user 510 is not stationary in response to receiving a communication over communications network 414 from a remote device that user 510 is inactive, has stopped using the remote device, or has left the detectable range of the remote device and is now in a location for which viewing area 506 is accessible. If control circuitry 304 determines that user 510 has left the detectable range of the remote device, the likelihood value may be assigned a non-zero value.

At step 1008, control circuitry 304 may generate a warning indication that is presented to user 502. For example, the warning indication may be generated by control circuitry 304 in response to determining that the likelihood value has exceeded or is equal to a particular threshold value. In some embodiments, this warning may be presented only once and may not be presented again until after a different warning indication is presented.

The process then proceeds to step 1010. If at step 1010 detecting circuitry 307 determines that user 510 is approaching viewing area 506, control circuitry 304 may assign a non-zero to the likelihood value that is based on the location of user 510. The process then proceeds to step 1012 and a warning indication is generated by control circuitry 304 and presented to user 502. For example, the warning indication may be generated by control circuitry 304 in response to determining that the likelihood value has exceeded or is equal to a particular threshold value. Control circuitry 304 can determine that user 510 is approaching viewing area 506 using any suitable method described herein. If at step 1010 control circuitry 304 determines that user 510 is not approaching viewing area 506, the process proceeds to step 1006.

If at step 1014 control circuitry 304 determines that intrusion by user 510 is imminent, the process proceeds to step 1016 and control circuitry 304 generates an intrusion indication that is provided to the user 502. Control circuitry 304 may determine that intrusion is imminent by using any suitable method described herein. For example, the intrusion indication may be generated by control circuitry 304 in response to determining that the likelihood value has exceeded or is equal to a particular threshold value. Control circuitry 304 may change the manner in which content is presented to user 502 by hiding the private content, changing the private content to safety content, or by any suitable combination thereof. The process concludes at step 1018 and may repeat continuously from step 1002. If at step 1014 control circuitry 304 determines that intrusion by user 510 is not imminent, the process proceeds to step 1010. For example, control circuitry 304 may determine that the likelihood value has dropped below a particular threshold value.

It should be understood that the above steps of the flow diagrams of FIGS. 9 and 10 may be executed or performed in any order or sequence not limited to the order and sequence shown and described in the figures. Also, some of the above steps of the flow diagrams of FIGS. 9 and 10 may be executed or performed substantially simultaneously, where appropriate.

The above-described embodiments of the present disclosure are presented for purposes of illustration and not of limitation, and the present disclosure is limited only by the claims which follow.

1. A method for providing a private viewing experience, the method comprising:
detecting that a first user is present at a media device that is presenting a first media content;
detecting that a second user is outside a viewing area of the media device;
determining a likelihood value related to a likelihood that the second user will enter the viewing area of the media device during a time period in the future; and
generating, based on the likelihood value, a first indication presented to the first user at the media device indicating that the second user is likely to enter the viewing area of the media device during the time period in the future.

2. The method of claim 1, wherein the generating is conditioned on a determination that a characteristic of the first media content matches a media content characteristic that is designated as private content.

3. The method of claim 1, wherein presenting the first indication to the first user comprises displaying a warning to the first user with the media device.

4. The method of claim 1, wherein presenting the first indication to the first user comprises automatically hiding the first media content and displaying a second media content to the first user with the media device.

5. The method of claim 4, wherein a characteristic of the second media content matches a media content characteristic that is designated as safety content.

6. The method of claim 1, further comprising:
comparing the likelihood value to a threshold value; and
in response to determining that the likelihood value is greater than or equal to the threshold value, presenting a second indication to the first user that is different from the first indication.

7. The method of claim 1, wherein detecting that the second user is outside the viewing area of the media device comprises monitoring activity of the second user with a remote device.

8. The method of claim 1, wherein determining the likelihood value comprises extrapolating a future location based at least on a previous position of the second user relative to the viewing area.

9. The method of claim 1, wherein the likelihood value varies as a function of the second user's location relative to the viewing area.

10. The method of claim 1, wherein a visual characteristic of the first indication varies as a function of the likelihood value.

11. A system for providing a private viewing experience, the system comprising:
control circuitry configured to:
detect that a first user is present at a media device that is presenting a first media content;
detect that a second user is outside a viewing area of the media device;
determine a likelihood value related to a likelihood that the second user will enter the viewing area of the media device during a time period in the future; and
generate, based on the likelihood value, a first indication presented to the first user at the media device indicating that the second user is likely to enter the viewing area of the media device during the time period in the future.

12. The system of claim 11, wherein the generating is conditioned on a determination that a characteristic of the first media content matches a media content characteristic that is designated as private content.

13. The system of claim 11, wherein presenting the first indication to the first user comprises displaying a warning to the first user with the media device.

14. The system of claim 11, wherein presenting the first indication to the first user comprises automatically hiding the first media content and displaying a second media content to the first user with the media device.

15. The system of claim 14, wherein a characteristic of the second media content matches a media content characteristic that is designated as safety content.

16. The system of claim 11, wherein the control circuitry is further configured to:
compare the likelihood value to a threshold value; and
present a second indication to the first user that is different from the first indication in response to determining that the likelihood value is greater than or equal to the threshold value.

17. The system of claim 11, wherein the control circuitry is further configured to monitor activity of the second user with a remote device.

18. The system of claim 11, wherein the control circuitry is further configured to extrapolate a future location based at least on a previous position of the second user relative to the viewing area.

19. The system of claim 11, wherein the likelihood value varies as a function of the second user's location relative to the viewing area.

20. The system of claim 11, wherein a visual characteristic of the first indication varies as a function of the likelihood value.

21-30. (canceled)
